(19) United States
(12) Patent Application Publication
(10) Pub. No.: US 2005/0200482 A1
(43) Pub. Date: Sep. 15, 2005

(54) Storage box alarm

(76) Inventors: William M. Kurple, St. Charles, MO (US); Vernon L. Diehl, Southbury, CT (US)

Correspondence Address: THOMPSON COBURN, LLP, ONE US BANK PLAZA, SUITE 3500, ST LOUIS, MO, 63101, US

(21) Appl. No.: 10/796,918

(22) Filed: Mar. 10, 2004

(51) Int. Cl. G08B 13/08

(52) U.S. Cl. 340/545.7; 340/686.1; 340/570

(57) ABSTRACT

An alarm is provided for a container including an enclosure, a door, a door latch, and an actuator to open the latch. The alarm includes a switch, a circuit, and an output. The actuator actuates the switch when it opens the latch. In turn, the circuit senses the position of the switch and drives the output if the latch is open. Additionally, the alarm may include a power supply that powers the circuit via the switch when the latch is open. The alarm may also include a guide that prevents relative movement in one direction between the actuator and the switch. A lock switch may also be connected in series with the actuator switch so that the circuit drives the output only when the latch is open and the lock is locked. Additionally, a housing fitted to a lip of the enclosure may contain the circuit.

### FIELD OF THE INVENTION

This invention relates generally to storage boxes and, more particularly, to alarms for storage boxes that may be located in the beds of pickup trucks.

### BACKGROUND OF THE INVENTION

Workers who frequently carry tools to their work sites often find it convenient to mount a container in the bed of a pickup truck. Doing so enables the worker to carry a large variety of tools and other belongings to distant locations without the need to load and unload the tools between jobs. Workers often leave the tools in the container for extended times between jobs. However, some tools are expensive and, accordingly, are subject to theft.

While locking the container provides some security for the tools, thieves might still pry open the lid, pick the lock, or otherwise obtain access to the tools. Thus, a need exists to raise an alarm when a container is opened in an unauthorized manner.

In practice, battery powered container alarms tend to discharge the battery too quickly thereby leaving the tools or other contents vulnerable. Even alarms powered by the vehicle battery will eventually drain the battery. Additionally, these vehicle-powered alarms require modification of the vehicle and accordingly require effort to install. Thus, a need exists for an inexpensive, low (or no) power container alarm.

### SUMMARY OF THE INVENTION

It is in view of the above problems that the present invention was developed. The invention includes methods and apparatus for safeguarding the contents of containers.

More particularly, the invention provides a number of advantages including smaller, lighter, and less expensive apparatus and methods for providing an alert when unauthorized persons enter containers. Moreover, the apparatus taught herein may be installed as original equipment or as retrofit kits on containers. Likewise, the methods may be used with original equipment or with retrofit kits. Accordingly, the present invention helps prevent the loss of valuable tools, equipment, and other belongings from containers.

In general, the invention utilizes low cost switches to detect the status of the lock and lid of the container. When the container lid is opened without the box first being properly unlocked, an alarm (e.g. an audible alert) is generated. Furthermore, power savings accrue from leaving the alarm in a standby, or un-powered, state until an attempted intrusion occurs.

In a first preferred embodiment, an alarm is provided for a container that includes an enclosure, a door, a door latch, and an actuator to open the latch. The alarm includes a switch, a circuit, and an output. The actuator closes the switch when it opens the latch. In turn, the circuit senses the position of the switch and drives the output if the latch is open. Additionally, the alarm may include a power supply that powers the circuit via the switch when the latch is open. The alarm may also include a guide that prevents relative movement in one (or more) direction between the actuator and the switch. A lock switch may also be connected in series with the actuator switch so that the circuit drives the output only when the latch is open and the lock is locked. Additionally, a housing fitted to a lip of the enclosure may contain the circuit and the guide.

In another preferred embodiment, a container is provided that includes an enclosure, a door, a latch, an actuator, and an alarm. The latch keeps the door closed except when opened by the actuator. Concurrently with opening the latch, the actuator also closes a switch. In turn, a circuit of the alarm senses the position of the switch and drives the output. Additionally, the container may fit in the bed of a pickup truck.

In a preferred embodiment, the present invention provides a method of detecting unauthorized entry into a container. The method includes opening a latch of the container with an actuator and sensing the position of the actuator. If the actuator position indicates the actuator opened the latch, then an alarm is raised. Moreover, power may be supplied to a circuit that senses the switch position if the actuator has opened the latch. Furthermore, the method may include fitting a housing for the circuit to a lip of the container. Also, the actuator may be guided to prevent relative motion, in at least one direction, between the actuator and the switch. Additionally, if the container includes a lock, the position of the lock may be sensed and an alarm triggered if the lock is locked and the latch is open.

In another preferred embodiment, an alarm for a container is provided that includes a power source, a switch, a circuit, and an output. The normally open switch connects to the power source and closes when the latch opens. The circuit connects to the switch and receives power therefrom when the switch closes. Thus, the circuit drives the output when the switch is closed. Furthermore, the switch may be closed by an actuator for the latch.

Another preferred embodiment provides an alarm for a container that includes a housing, a switch, a circuit contained in the housing, and an output. The housing is shaped to correspond to the shape of the container. The actuator opens the latch and closes the switch. Meanwhile, the circuit senses the switch position and drives the output if the switch indicates the actuator has opened the latch.

Further features and advantages of the present invention, as well as the structure and operation of various embodiments of the present invention, are described in detail below with reference to the accompanying drawings.

### BRIEF DESCRIPTION OF THE DRAWINGS

The accompanying drawings, which are incorporated in and form a part of the specification, illustrate the embodiments of the present invention and together with the description, serve to explain the principles of the invention. In the drawings:

FIG. 1 illustrates container in accordance with the principals of the present invention;

FIG. 2 illustrates a perspective view of the container of FIG. 1;

FIG. 3 illustrates a plan view of an alarm in accordance with a preferred embodiment of the present invention;

FIG. 4 illustrates a schematic of a preferred embodiment of the present invention;

FIG. 5 illustrates a schematic of another preferred embodiment of the present invention;

FIG. 6 shows a schematic of yet another preferred embodiment of the present invention;

FIG. 7 depicts a schematic of another preferred embodiment of the present invention;

FIG. 8 illustrates yet another schematic of a preferred embodiment of the present invention;

FIG. 9 depicts a state transition diagram of a preferred embodiment of the present invention;

FIG. 10 shows a state transition table of the diagram of FIG. 9; and

FIG. 11 shows a preferred mounting arrangement for alarms in accordance with a preferred embodiment of the present invention.

### DETAILED DESCRIPTION OF THE PREFERRED EMBODIMENTS

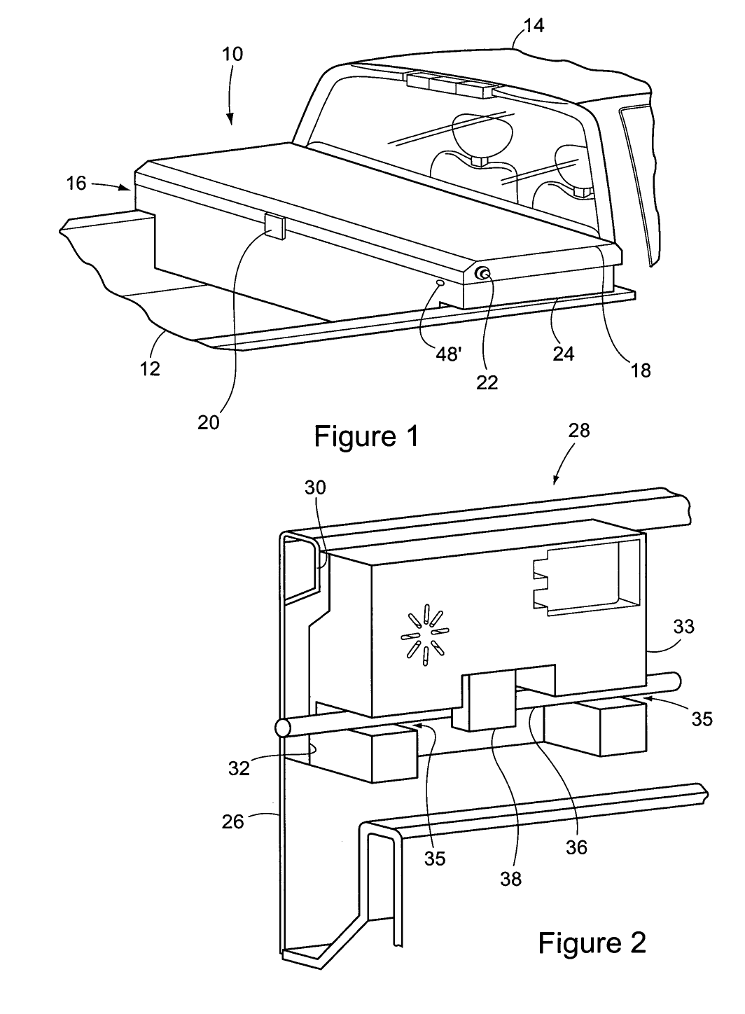

Referring to the accompanying drawings in which like reference numbers indicate like elements, FIG. 1 illustrates a container in accordance with a preferred embodiment of the present invention.

To provide security against unauthorized intrusions into the container 10, the present invention provides alarms for sensing a number of trip mechanisms to trigger the alarm. Herein, a “trip” will refer to a mechanism that may change between a tripped and an untripped condition, whereas “trigger” refers to activating an alarm based on a trip being changed to a tripped condition (or in the case of a switch, moved to a tripped position). Thus, trip mechanisms include, but are not limited to: locks with locked and unlocked positions, lids with open and closed positions, latches with latched and unlatched positions, latch actuators with positions for latching and unlatching the latch, and switches and sensors for sensing the same.

With reference now to FIG. 1, the storage box 10 may sit in a bed 12 of a sports utility vehicle or pickup truck 14 as shown. Typically, the storage box 10 includes a bottom, or enclosure 16, and a lid, top, or door 18 and may be a container. The lid 18 pivots up along hinges (not shown) along the back of the container 10. A latch 20 (shown externally for illustrative purposes) serves to secure the lid 18 to the bottom 16. Additionally, a lock 22 may provide additional security for the contents of the enclosure 16 by locking the door 18 closed against the enclosure 16. Of course, the enclosure 16 includes a pair of sidewalls 24, a front wall 26, and a rear wall (not shown).

In operation, the user gains access to the interior of the bottom 16 by first turning the lock 22 with a key (not shown). Then, the user pushes against the lock 22 that may be configured to resemble a button to unlatch the latch 20. An actuator (to be discussed more herein) may urge the latch 20 to release the lid 18 when the user pushes on the lock 22. The user thereafter, opens the lid 18 to access the interior. Thereafter, the user closes the lid 18 whereupon the latch may be spring loaded to close and re-secure the door 18. Finally, the user may lock the lock 22.

With reference now to FIG. 2, an alarm unit 28 in accordance with a preferred embodiment of the present invention is illustrated. The alarm 28 is shown in relation to a lip 30 of the wall 26, and having a rear housing 32, and a front cover 33. The front cover 33 defines a pair of notches 35 through which an actuator rod 36 passes. On the actuator rod 36 an adaptor 38 is also shown. The alarm 28 is mounted to the inside of the front wall 26 and just under the lip 30. Together, the covers 32 and 33 house the internal components of the alarm 28.

Typically, the lip 30 is included in many containers 20 to add structural rigidity to the container 10. The lip 30 may be of any appropriate shape to achieve its intended purpose. Here the lip 30 has a channel-like configuration to strengthen the upper edge of the bottom 16. The alarm 28 has a rear wall 32 having a shape conforming to the lip 30 and the wall 26 of the container so that the alarm fits snugly against, or mates with, the lip 30 and wall 26. Also, the dimensions of the alarm 28 are such that it can be installed behind the actuator 36 without removing the actuator 36 from the container 10. Note that sliding the guides 35 over the actuator 36 and then rotating the alarm 28 in place against the wall 26 facilitates installation. Once fastened in place, the abutting relationship of the lip 30, wall 26, and rear housing 32 fixes the position of the alarm 28 in relation to the enclosure 16. As will be appreciated shortly, the actuator rod 36 is fixed relative to the enclosure 16 (except longitudinally).

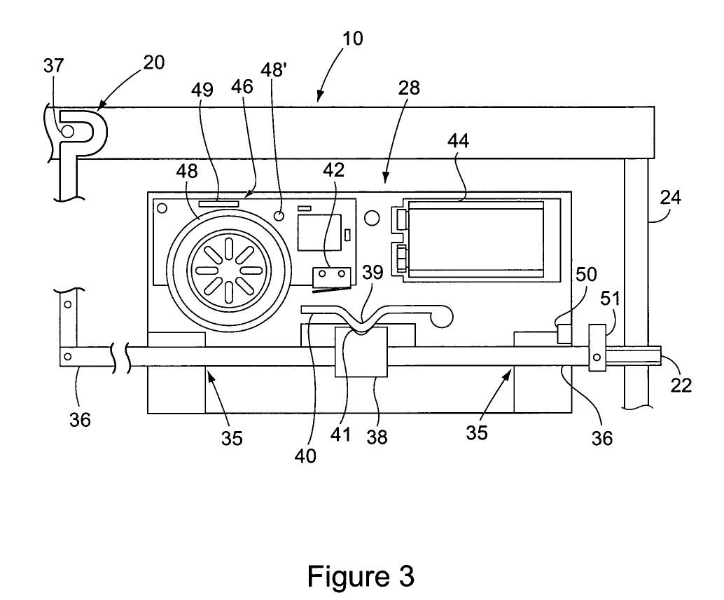

The cover 33 detaches from the rear housing 32 to allow access to internal components of the alarm 28. As shown in the plan view of FIG. 3 with the front cover 33 removed, the alarm 28 is seen cooperating with the actuator rod 36. The lock 22 is located at one end of the actuator rod 36 where the rod 36 penetrates the sidewall 24 of the enclosure 16. In a manner well known in the art, the lock 22 prevents the rod from moving longitudinally until the lock 22 is unlocked with a key. Toward the opposite end of the rod 36, a latch 20 is illustrated schematically as holding a post 37 (rigidly coupled to the lid 18) to prevent the lid 18 from opening unless the latch 20 is opened.

In operation, the user unlocks the lock 22 with a key and pushes against the lock 22 to move actuator rod 36 longitudinally. In turn, the actuator rod 36 causes the latch 20 to pivot clear of post 37. Thus, post 37 may then move upward with the lid 18 when the user opens the lid 18. Accordingly, by unlocking the lock 22 and pushing the actuator 36, the user may gain access to the contents of the container 10 in a manner well known in the art. However, unauthorized persons may also attempt to gain such access. Typically, they pick, circumvent, or overcome either (or both of) the latch 20 or lock 22. Subsequently, they lift the lid 18 to gain unauthorized entry into the container 10.

With continuing reference to FIG. 3 the following additional components are illustrated: an adaptor 38, a lever arm 40, a sensor 42, a power source 44, a circuit (board) 46, an alarm output 48, and a sensor 49. Of course, the speaker 48 is in electrical communication with the circuit board 46 to receive a signal therefrom in response to actuation of switch 49. The adaptor 38 is mounted to the actuator rod 36. It is positioned on the rod 36 so that before the actuator rod 36 is pushed to the left to open latch 20, an inverted ridge 41 on the lever arm 40 rests in a detent on the top of the adaptor 38. When the actuator rod 36 moves longitudinally to open the latch 20, the ridge 41 rides up and out of the detent. In turn, the switch 42 is secured to the printed circuit board 46 at a location adjacent the distal end of the lever arm 40 so that an upward movement of the lever arm 40 causes switch 42 to close. Thus, when the user pushes actuator rod 36 to open latch 20, the adaptor 38 moves longitudinally with the rod 36. As the adaptor 38 moves, inverted ridge 39 of the lever arm 40 rides up and out of the detent 41 in the adaptor 38. As a result, the lever arm 40 pivots up and presses against switch 42. Sensor 42 (that may include a normally open reed switch) in turn closes. Since switch 42 has closed, this provides an indication to the circuit 46 recognizing that actuator 36 has been pushed. Circuit 46 then inhibits an alarm, allowing switch 49 to activate without causing an alarm output 48. Note that in the preferred embodiment shown the power source 44 is a battery and the output is a speaker 48.

In another preferred embodiment, the alarm 28 may also include a lock sensor 50. The purpose of the lock sensor 50 is to monitor the status of the lock 22 and to enable the circuit 46 to use that status in determining whether to sound an alarm. More particularly, if the lock 22 is locked and the lid opens, the combination is indicative of an unauthorized attempt to open the container 10. The sensor 50 senses the position of the lock 22 via an element 51. Generally, the element 51 turns with the lock 22 as the lock is being (un)locked. Accordingly, sensor 50 senses the presence or absence of the element 51 and changes state accordingly. Preferably, the sensor/element combination constitutes a magnetic reed switch for sensing the position of the lock 22. The guides 35 prevent relative motion between the rod 36 and the switches 42 and 50, with respect to vertical motion and may be configured to prevent relative motion forward or rearward relative motion as well.

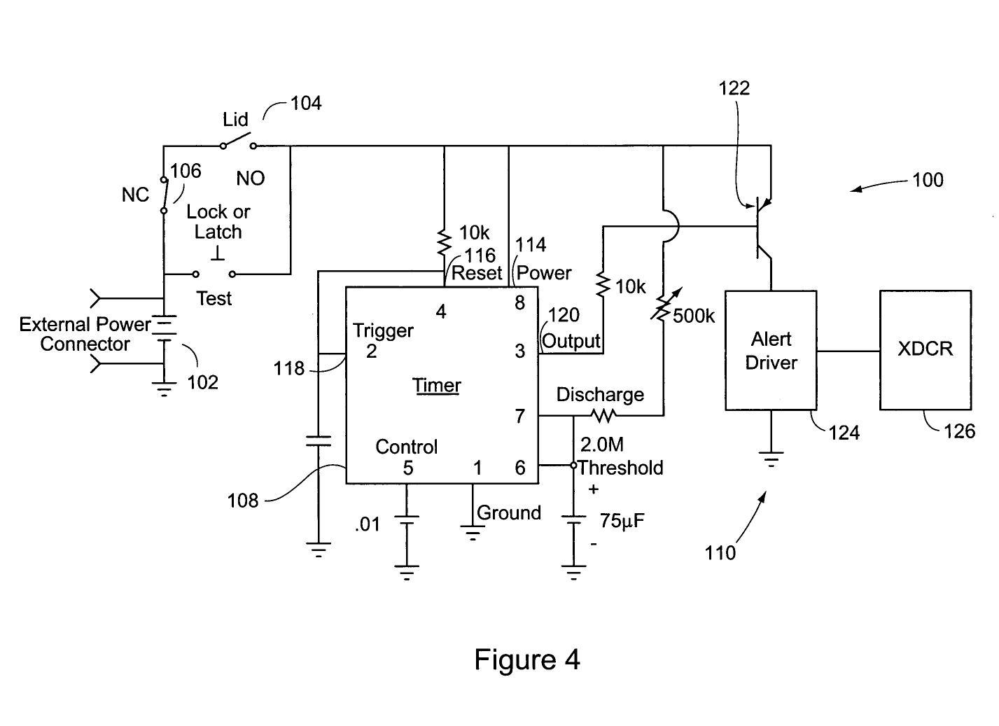

Now turning to FIG. 4, a schematic of a circuit in accordance with the principals of the present invention is shown. The circuit 100 includes a power source 102 (that may be the battery 44 of FIG. 3), a lid switch 104 (that may be the actuator switch 42), a lock switch 106 (that may be latch switch 42 or lock switch 50), a timer 108, and an output section 110. The power source 102 may be a separate battery, a battery of the vehicle electrical system, a solar cell, or any suitable power supply. While an internal D.C. power source 102 is shown, it will be understood that the present invention is not thereby limited.

The switches 104 and 106 sense the positions of the lid actuator and the lock respectively. In a preferred embodiment the lid switch 104 is normally open and the lock switch 106 is normally closed. Additionally, the switches may be any type of switch such as (but not limited to) reed switches, magnetic switches (i.e. a switch (de)activated by the absence or presence of a magnetic field), knife switches, push buttons, optical sensors, etc. As shown, the switches 104 and 106 are wired in series with the power supply. Accordingly, when the lid is open and the lock is locked, both switches are closed thereby completing a path from the power source 102 to the timer 108. In the preferred embodiment illustrated by FIG. 4, the timer 108 is a model number 555 timer available from Phillips Semiconductor of Eindhoven, The Netherlands.

The output from the switches 104 and 106 is connected to the power, reset, and trigger pins 114 to 118 of the timer 108. Accordingly, when the power reaches the timer 108, the timer begins timing with its output 120 driven to an “on” condition. In turn, the output 120 turns on a transistor 122 in the output section 110. Since the emitter of the transistor 122 is also connected to the output of the switches 104 and 106, as shown, the transistor turns on a driver 124 of the output section 110. The output driver 124 produces a signal or waveform suitable for driving a device to produce an alarm. The alarm 126 may be a piezoelectric transducer or other suitable device for activating an appropriate alarm. The alarm may be a siren, a flashing light, an electromagnetic code, a signal sent to the vehicle's alarm system or to a device carried by the user (i.e. a silent alarm). After a preselected time, the timer 108 times out causing the output 120 to turn off. Preferably, the timer is set to sound the alarm for a sufficient time to scare off an intruder but not so long as to drain the battery power source. Further features may be added to the alarm 100 such as a mercury switch to sense tilting of the container 10 (e.g. because the container is being lifted from the truck bed). Because no current flows from the power source 102 until both switches are closed, the alarm 100 consumes little power.

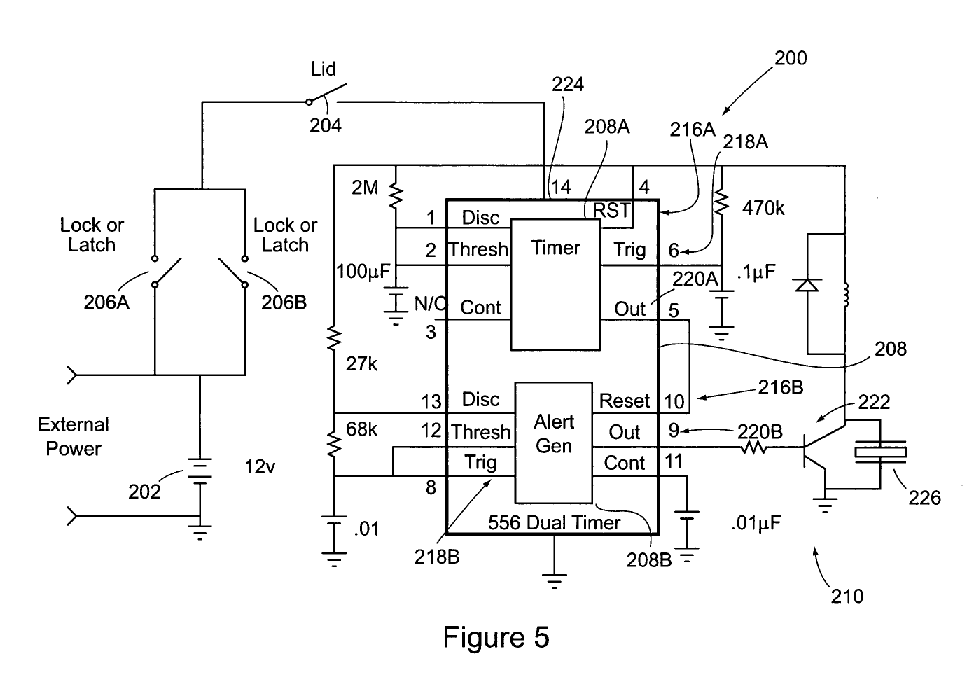

FIG. 5 shows a schematic of another preferred embodiment of the present invention. The illustration of two lock switches 206A and 206B instead of one lock switch, as in FIG. 4, indicates that the alarm circuit 200 may work with either (or both) of the lock switches 206. In one alternative, the switch 206A is configured for a particular model of container, while the lock switch 206B is configured for another model. Only one switch 206 is connected to the circuit for a given application. For instance, switch 206A may be a knife switch while the switch 206B may be a reed switch used with a smaller container wherein a reed switch could be employed. In another alternative, lock switch 206A may sense the position of a lock on one container and switch 206B may sense the position of a lock of another container on the same truck (or of different locks on the same container). Thus, when either lock switch 206 indicates that a lock is locked and the lid switch 204 indicates the lid is open, the alarm 226 will sound. Of course, two, or more, lid switches 204 may also be employed.

Also shown by FIG. 5, the present embodiment includes a dual timer 208. The dual timer 208 may be a model 556 timer (also available from Phillips Semiconductor of Eindhoven, The Netherlands). The dual timer 208 provides a first timer 208A that generates the alarm and a reset timer 208B that resets the alarm after a pre-selected time. It should also be noted that for applications involving a power supply 202 of sufficient strength, it is possible to drive the piezoelectric transducer 226 directly from output 220B. Thus, the transistor 222 may be omitted from the circuit 200.

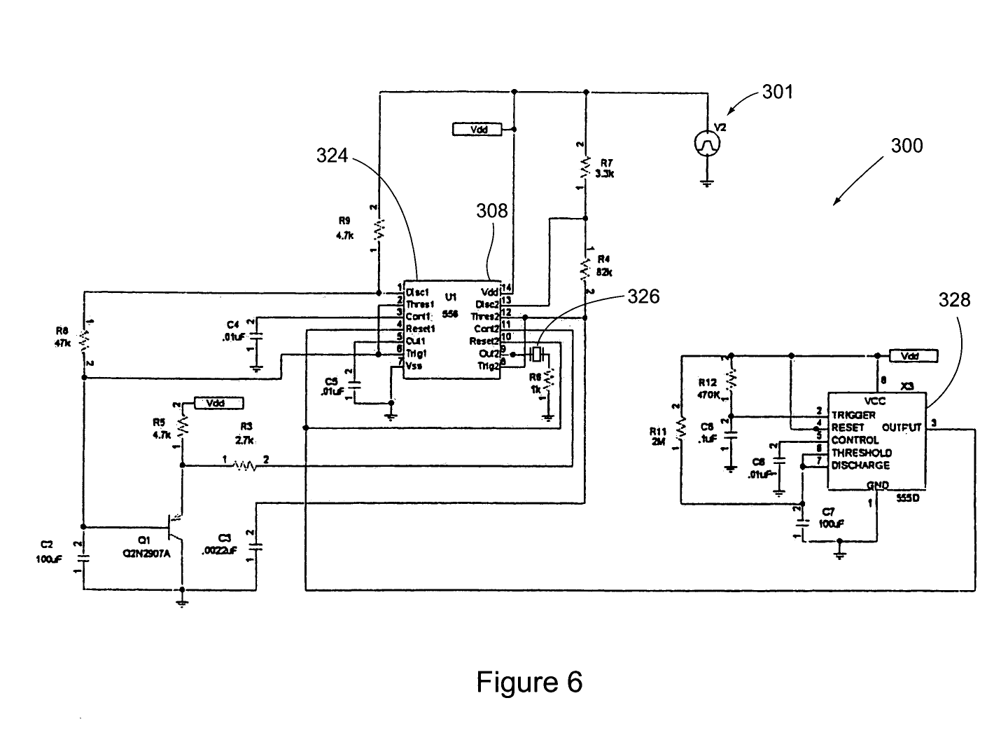

Turning now to FIG. 6, another alarm circuit in accordance with the present invention is shown. The current embodiment includes three timers, one to generate an alarm, another to modulate the alarm signal, and the third to reset the alarm. FIG. 6 depicts the combination of timing circuits and components which realize an output section in accordance with the present embodiment. The pulse 301 indicates the output from a controller or other control circuitry which causes the output section to activate. A model 556 dual timer is employed to provide an alarm generator 308 (via one of two timers internal to the 556 chip). The dual timer also provides an alarm driver 324 that modulates the alarm signal from the alarm generator 308 with a low frequency sweep. Thus, the output of the circuit 300 is a siren like wail provided by one inexpensive 556 dual timer chip. Additionally, a model 555 single timer chip may be included to provide a reset timer 328 for quieting the alarm after a pre-selected time.

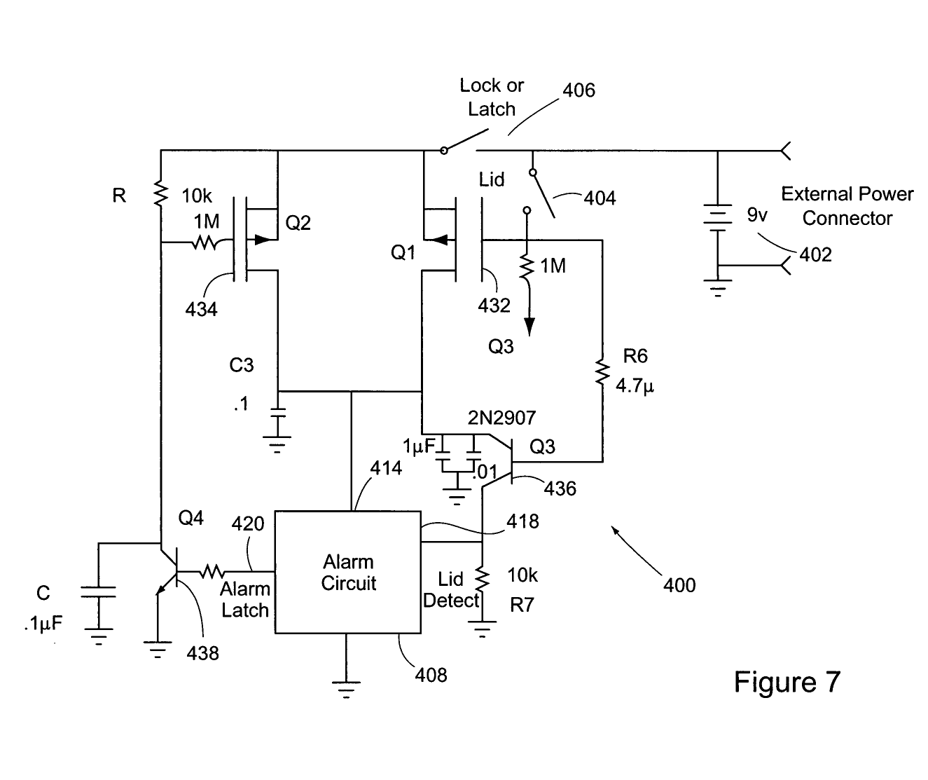

With reference now to FIG. 7, a circuit 400 includes a programmable alarm generator 408. In addition to providing a programmable alarm, the current embodiment also provides an alternative switch arrangement and a latching circuit to latch the alarm in the “on” condition. When switches 404 and 406 indicate that an intrusion has been attempted, the alarm generator 408 latches an alarm output 420 to a “high” condition with a transistor 438 biasing transistor 434 on (when the alarm is activated). Thereafter, the alarm generator 408 determines whether to turn off the alarm indication 420. It should be noted that the alarm generator 408 can include any suitable programmable device known in the art. Exemplary pseudo code for the programmable generator 408 is shown below.

EXEMPLARY PSEUDO CODE FOR A PROGRAMMABLE ALARM
GENERATOR

| | |
|---|---|
| LID CLOSED | ;Transistor 432 off, no current to alarm |
| | Or transistor 436. |
| BOX LOCKED | ;This action provides bias. Transistor |
| | 434 bias on supplying power to power |
| | alarm generator 408. |
| SET ALARM LATCH | ;Transistor 438 biased on locking |
| | transistor 434 on. |
| ALARM STARTS | |
| CHECK LID_STATUS | ;Lid is checked to see if it is open or not. |
| If LID_CLOSED | |
| DELAY ‘CHIRP TIME’ | ;Provides timer for ‘chirp.’ |
| CLEAR ALARM LATCH | ;Shut down alarm. |
| ELSE | |

CONTINUE ALARMING FOR ALARM TIME
END IF

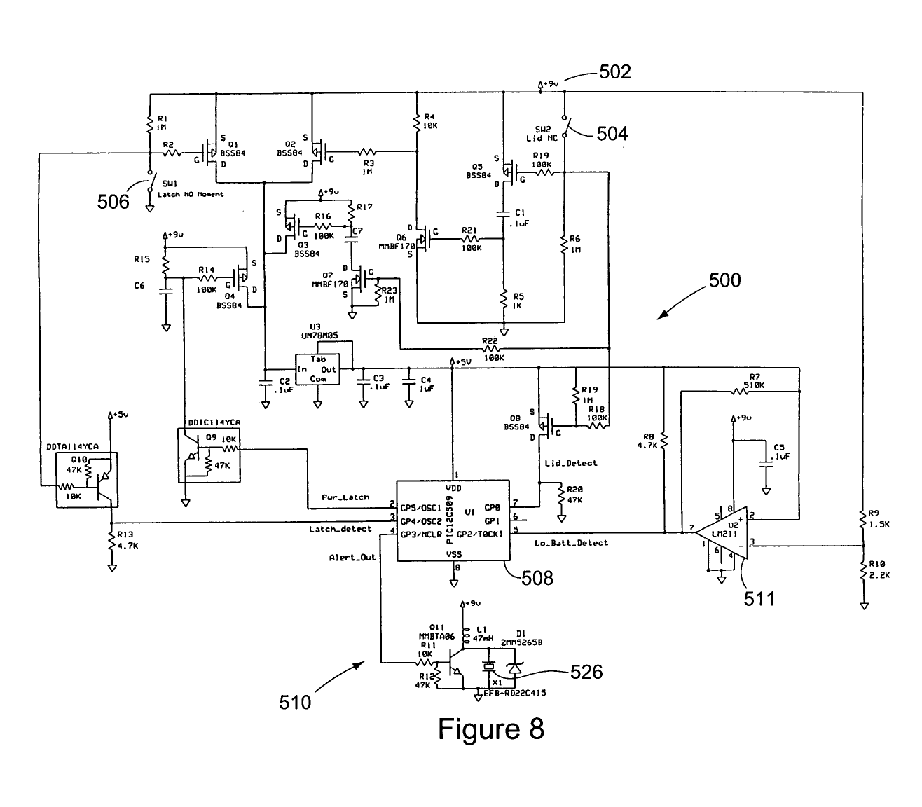

Turning now to FIG. 8, a schematic of another preferred embodiment of the present invention is shown. The current embodiment provides a low battery detector, another alternate switching configuration, and an alternative programmable alarm. The alarm 500 includes a power supply 502, a normally closed lid switch 504, a normally open (momentary) latch switch 506, a controller 508, an output section 510, and a low battery detector 511. As such, the present embodiment provides protection against intrusions wherein the intruder attempts to open the lid without actuating the latch (e.g. by prying the lid open).

In a preferred embodiment, the controller 508 is a PIC12C509 microcontroller available from Microchip Technology, Inc. of Chandler, Ariz. Accordingly, the controller 508 may be programmed to perform a large number of functions. In particular, because the controller 508 may be programmed to read the sensed position of the latch switch 506 on a rapid basis, the latch switch 506 may be a momentary switch. Thus, the power use associated with the closure of switch 506 may be reduced by an amount corresponding to the reduction in time that switch 506 is closed.

Because the controller 508 has a number of programmable input/output ports, additional enhancements such as the low battery detector 511 may be added. Thus, if the battery detector 511 detects a drop in the voltage provided by the power supply 502, the controller 508 may be programmed to generate a different output to indicate that the battery is low. For instance, the output 526 may be made to chirp upon detection of a low power supply voltage.

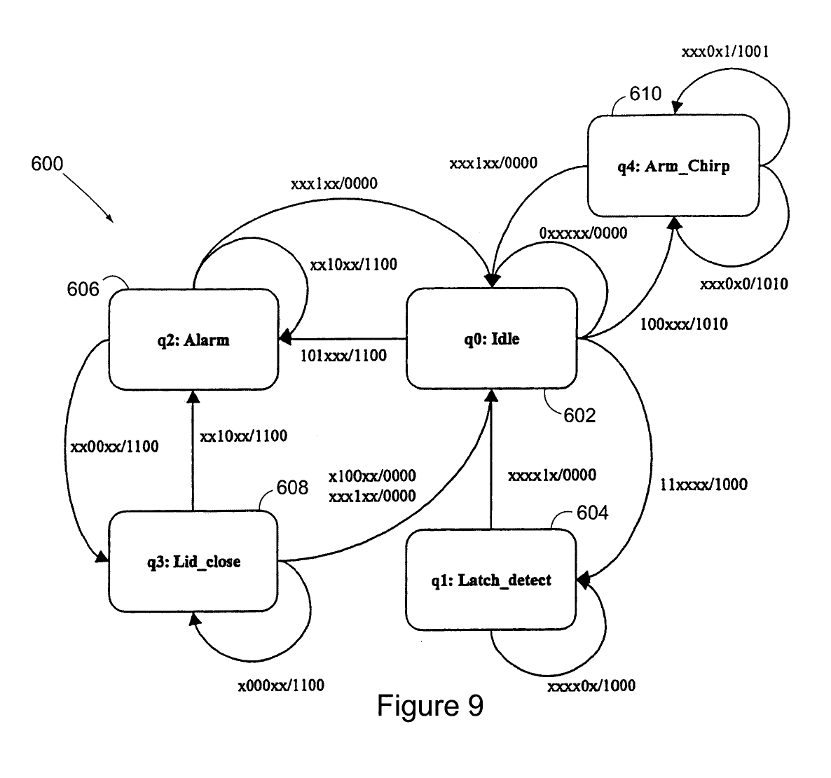

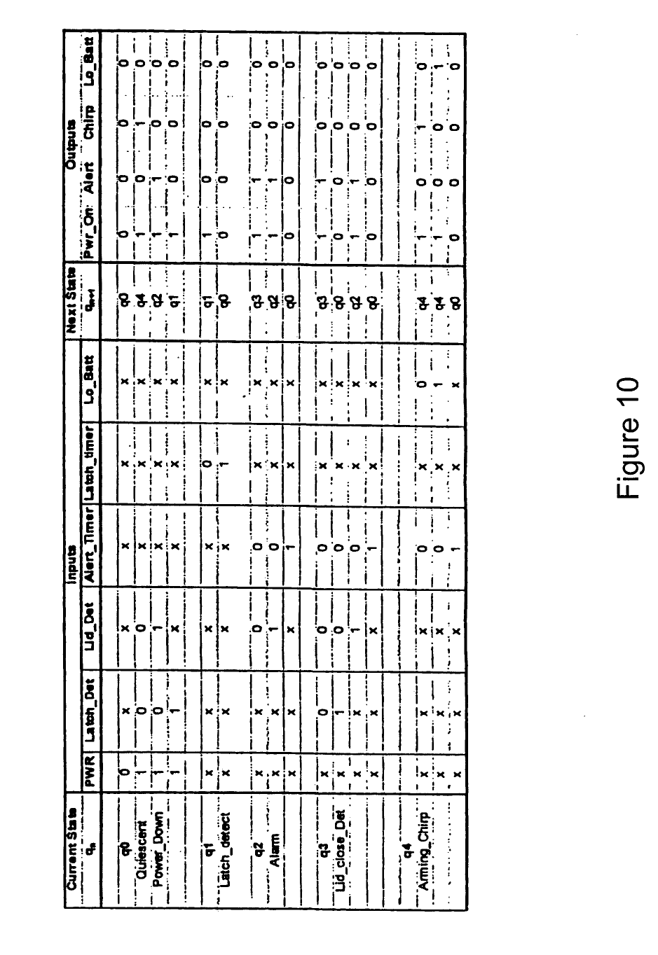

Turning now to FIG. 9, an exemplary state transition diagram 600 is shown for a programmable alarm generator in accordance with a preferred embodiment of the present invention. FIG. 10 shows the corresponding state transition table 700. The diagram of FIG. 9 shows five states 602 to 610. In the idle state 602, the alarm generator (e.g. generator 508 of FIG. 8) stays powered down until it receives power through the activation of either the lid switch or the latch switch (e.g. switches 504 and 506). If a latch switch activation causes the alarm generator to receive power (by actuation of the latch in preparation for a legitimate entry into the container), the generator transitions to the latch detect state 604. A brief delay occurs before the generator thereafter returns to the idle state 602. Because the latch switch is a momentary switch, the delay masks the lid switch while the lid is being opened. Accordingly, the delay prevents the generator from alarming during authorize openings of the lid. On the other hand, if a lid switch activation causes the power up (e.g. an attempt is made to pry open the lid without actuating the latch), the generator enters the alarm state 606. In the alarm state 606, the generator outputs an alarm and may leave the alarm state 606 if one of the two following conditions occurs. First, if the lid closes, the generator will transition to the lid closed state 608. However, the generator will continue to produce the alarm. Otherwise, upon timing out, the generator will transition to the idle state 602 and silence the alarm accordingly.

As discussed above, the alarm generator enters the lid closed state 608 from the alarm state 606 upon detection of lid closure. The generator may exit the lid closed state 608 if one of the following three conditions occurs. First, if a latch actuation occurs (indicating that the user has a key), the generator transitions to the idle state 602. Thus, the user may silence the alarm by closing the lid and operating the latch to reopen the lid. If the lid is simply reopened without using the latch, the generator returns to the alarm state 606. Otherwise, the generator may time out and transition to the idle state 602 accordingly. Upon a subsequent closure of the lid switch, the generator then reactivates the alarm.

The generator may also have an arm chirp state 610. Under normal use, at a construction site for instance, the container generally remains unlocked and open for tool retrieval. Under these circumstances the generator will revert to the idle state 602 to conserve power. When the lid is closed, power is supplied to the generator and since neither switch actuation is detected, the generator proceeds to arm the alarm. As long as the alarm is not set, the generator may sense whether the strength of the battery is satisfactory. If so, the generator will output a chirp indicative of a good battery. If the battery strength has dropped below a pre-selected level, the generator may produce a different chirp indicative of a weak battery.

EXEMPLARY STATE MACHINE PSEUDO CODE

| | | |
|---|---|---|
| Q0 | CALL PWR_ON | ;Idle state 602 |
| | SWITCH_CHECK | |
| | INITIALIZE SW_CHECK_TIMEOUT | |
| | CALL PWR_ON | |
| | IF LATCH | |
| | {SET OUTPUT 1000 | |
| | GO TO Q1} | |
| | IF LID | |
| | {SET OUTPUT 1100 | |
| | INITIALIZE ALERT_TIMER | |
| | GO TO Q2} | |
| | LOOP UNTIL SW_CHECK_TIMEOUT | |
| | SET OUTPUT 1010 | |
| | INITIALIZE ARM_TIMER | |
| | CHECK LO_BATTERY | |
| | IF SET ALERT = LO_BATT | |
| | ELSE | |
| | ALERT = ARM_CHIRP | |
| | END IF | |
| | GOTO Q4 | |
| Q1 | CALL PWR_ON | ;Latch detect |
| | | state 604, |
| | | delay loop |
| | IF LATCH_TIMEOUT | |
| | {SET OUTPUTS 0000 | |
| | GOTO END} | |
| | ELSE | |
| | LOOP TO Q1 | |
| Q2 | CALL PWR_ON | ;Alarm state |
| | | 606 |
| | CHECK LID_DET STATUS | |
| | IF CLEAR | |
| | {SET OUTPUT 1110 | |
| | GOTO Q3} | |
| | CHECK ALERT_TIMER | |
| | IF EXPIRED | |
| | {SET OUTPUT 0000 | |
| | GOTO END} | |
| | GOTO Q2 | |
| Q3 | CALL PWR_ON | ;Lid close |
| | | state 608 |
| | CHECK LATCH_DET | |
| | IF SET | |
| | {SET OUTPUT 0000 | |
| | GOTO END} | |
| | CHECK LID_DET | |
| | IF SET | |
| | {SET OUTPUT 1100 | |
| | GOTO Q2} | |
| | CHECK ALERT_TIMER | |
| | IF EXPIRED | |
| | {SET OUTPUT 0000 | |
| | GOTO END | |
| | GOTO Q3 | |
| Q4 | CHECK ARM_TIMER | ;Arm_chirp |
| | | state 610 |
| | IF EXPIRED | |
| | {SET OUTPUT 0000 | |
| | GOTO END} | |
| | GOTO Q4 | |
| END | | |

As has been described, apparatus provided by the invention operate by sensing the status of the container lock, latch, and lid. While various sensors may be used, preferred embodiments utilize magnetic reed switches. The nature of these switches makes them well suited to the applications of the invention, in part, because they are durable with respect to mechanical shock and other environmental abuse. In addition, the use of reed switches provides small and inexpensive alarms as taught herein. Otherwise, relays, push buttons, transistors, FET switches or any suitable sensing mechanism may be employed to sense the container status.

Likewise, the present invention is not limited by the specific circuitry discussed herein. The alarm circuits may employ microprocessors, special application ICs, discreet devices, PROMs, analog devices, and the like without deviating from the spirit and scope of the present invention. Moreover, the alerts produced are not limited by those specifically discussed herein. Possible alerts include wailing sirens, flashing lights, LED indications, silent alarms (e.g. a radio frequency pager that vibrates), or even the production of obnoxious smells or spray ink (to mark the intruder) may be employed. In one preferred embodiment, the output is an LED 48′ mounted on the circuit board 46 (of FIG. 3) and positioned so that it shines through an aperture in the front wall 26 of the container 10 (see FIG. 1). Preferentially, the LED 48′ blinks whenever the alarm has power so as to warn intruders that the container 10 is monitored by the alarm 28. Additionally, because the LED 48′ may be programmed to blink at a different rate if the power supply is low, the present embodiment allows the owner to readily check the status of the power supply.

Additional circuitry may be added to timeout, or shutdown, the alarm following an intrusion. A test feature may also be added to allow the user to verify functionality of the circuit (e.g. battery strength and circuit operation). Also, a key fob, or other remote control (e.g. radio frequency), may be provided to allow the user to arm, disarm, override and otherwise control the apparatus provided herein.

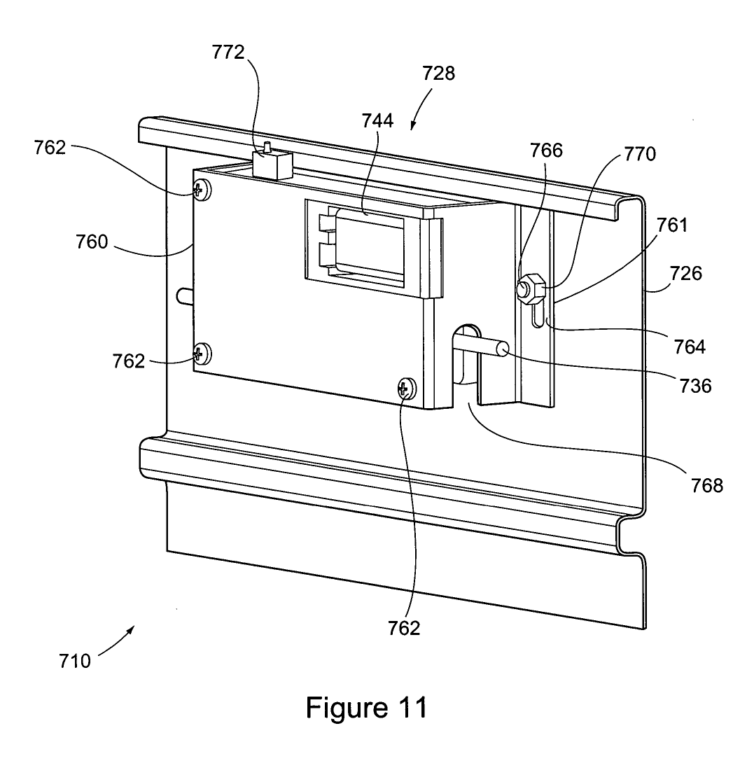

In another preferred embodiment illustrated by FIG. 11, an alternative mounting system is shown for an alarm 728. The mounting system shown includes an adaptor plate 760 with a channel-like configuration that extends generally around the alarm 728 and ends at flanges 761 on either side of the alarm The plate includes screw holes for a set of screws 762, slots 764 on the flanges for a bolt or stud 766, and another slot 768 for an actuator rod 736. Additionally, a nut 770 is shown. In operation, the alarm 728 is first mounted to the adaptor 760 using the screws 762. Then the assembly is slipped over the actuator rod 736 using the slots 768. Approximately simultaneously, the slots 764 slip over the studs 766 which are welded to the wall 726. Thereafter the nuts 770 are used to secure the assembly to a wall of the container 710. Here, the alarm 728 is shown secured to the inside of front wall 726. In one preferred embodiment the adaptor 760 extends above and below the alarm 728, thereby providing protection against mechanical abuse to the alarm 728. Though many other mounting locations (e.g. external to the container 710) are possible. Additionally, a lid switch 772 is affixed, and wired, to the alarm 728 and positioned to sense the opening and closing of the lid.

Those skilled in the art will recognize that many mounting arrangements may be provided for the alarm 28 in addition to those discussed herein. The embodiments shown are exemplary and are not intended to limit the spirit or scope of the invention. For instance, a pair of metal screws or brackets could be provided on which to mount the alarm 728 to the container 710 instead of the systems illustrated.

Further advantages provided by the present invention include, for instance, enhanced security for belongings contained in truck containers. Moreover, the present invention provides rugged and inexpensive alarms to protect containers against unauthorized entry. Furthermore, the present invention provides methods for safeguarding those belongings.

In view of the foregoing, it will be seen that the several advantages of the invention are achieved and attained. For instance, the invention may be employed in any application wherein the opening of a locked container indicates a possible intrusion. Designs in accordance with the principles of the present invention could be employed in any storage container (e.g. toolboxes, gun cases, plastic storage bins, footlockers, etc.). Likewise, existing storage containers may be retrofitted with a kit in accordance with preferred embodiments of the present invention. Moreover, apparatus provided by the invention may be powered by small batteries, particularly those capable of withstanding the temperature extremes of weather experienced by outdoor equipment. In other preferred embodiments, installation of alarms may be facilitated by connection of an alarm to the vehicle battery via an appropriate connector. Furthermore, through a unique arrangement of the switches the present invention minimizes power consumption. Thus, the invention extends battery life for the container alarms.

The embodiments were chosen and described in order to best explain the principles of the invention and its practical application to thereby enable others skilled in the art to best utilize the invention in various embodiments and with various modifications as are suited to the particular use contemplated.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

1. An alarm for a container including an enclosure defining an interior volume for holding tools or other belongings, a door adapted to move between an open position allowing access to the interior volume of the enclosure and a closed position for closing the enclosure, and a trip having a tripped condition and an untripped condition, the alarm comprising:
a trip sensor operable between a first condition when the trip is in its untripped condition and a second condition when the trip is changed to its second condition; and
a circuit adapted to sense the condition of the trip sensor, the circuit being adapted to drive an output when the trip sensor is in its second condition.

2. The alarm according to claim 1, the trip sensor further comprising being adapted to sense the position of a latch actuator for a latch of the container, the latch actuator being the trip, the latch moveable between a latched position to secure the door to the enclosure when the door is in its closed position and an unlatched position wherein relative movement of the door and enclosure is permitted, and the actuator operatively connected to the latch in a manner so that movement of the actuator from an untripped position to a tripped position causes the latch to move from its latched position to its unlatched position, the tripped condition of the trip being the latch actuator being in its tripped position.

3. The alarm according to claim 2, the trip sensor further comprising being further adapted to sense the position of a lock of the container, the lock to prevent opening of the door when in a first position, to permit opening of the door when in a second position, the trip being the actuator and the lock, the tripped condition being the actuator in its tripped position and the lock being in its first position.

4. The alarm according to claim 1, further comprising a power supply, the trip sensor connecting the power supply to the circuit when the trip sensor is in its second condition.

5. The alarm according to claim 1, wherein the trip sensor further comprises a lock switch and an actuator switch connected in series.

6. The alarm according to claim 1, wherein the trip sensor further comprises a reed switch, its second condition being closed.

7. The alarm according to claim 1, wherein the trip sensor further comprises a magnetic switch.

8. The alarm according to claim 1, further comprising a guide, the trip to slidably engage the guide, whereby the guide prevents relative movement between the trip and the trip sensor in at least one direction.

9. The alarm according to claim 1, further comprising a housing containing the circuit and corresponding in shape to a lip of the container, whereby the alarm to mate with the lip.

10. The alarm according to claim 1, further comprising an adaptor to couple to the trip and to engage the trip sensor when the trip is in its tripped position.

11. The alarm according to claim 1, wherein the output further comprises an audible alert.

12. The alarm according claim 1 wherein the trip moves generally axially to change from its untripped to its tripped condition.

13. The alarm according to claim 1 wherein the output further comprises an LED, the LED mounted in a manner so that it is visible from outside of the container.

14. A container comprising:
an enclosure defining an interior volume for holding tools or other belongings;
a door adapted to move between an open position allowing access to the interior volume of the enclosure and a closed position for closing the enclosure;
a trip having a tripped condition and an untripped condition; and
an alarm comprising:
a trip sensor operable between a first condition when the trip is in its untripped condition and a second condition when the trip is changed to its second condition; and
a circuit adapted to sense the condition of the trip sensor, the circuit being adapted to drive an output when the trip sensor is in its second condition.

15. The container according to claim 14, further comprising:
a latch moveable between a latched position to secure the door to the enclosure when the door is in its closed position and an unlatched position wherein relative movement of the door and enclosure is permitted,
a latch actuator being the trip and operatively connected to the latch in a manner so that movement of the actuator from an untripped position to a tripped position causes the latch to move from its latched position to its unlatched position, and
the trip sensor further adapted to sense the position of the latch actuator.

16. The container according to claim 15, further comprising a lock to prevent opening of the door when in a first position, to permit opening of the door when in a second position, the trip sensor being further adapted to sense the position of the lock, the trip being the actuator and the lock, the tripped condition being the actuator in its tripped position and the lock being in its first position.

17. The container according to claim 14, further comprising a power supply, the trip sensor connecting the power supply to the circuit when the trip sensor is in its second condition.

18. The container according to claim 14, wherein the trip sensor further comprises a lock switch and an actuator switch connected in series.

19. The container according to claim 14, wherein the trip sensor further comprises a reed switch, its second condition being closed.

20. The container according to claim 14, wherein the trip sensor further comprises a magnetic switch.

21. The container according to claim 14, further comprising a guide, the trip to slidably engage the guide, whereby the guide prevents relative movement between the trip and the trip sensor in at least one direction.

22. The container according to claim 14, further comprising a housing containing the circuit and corresponding in shape to a lip of the container, whereby the alarm to mate with the lip.

23. The container according to claim 14, further comprising an adaptor to couple to the trip and to engage the trip sensor when the trip is in its tripped position.

24. The container according claim 14, wherein the trip moves generally axially to change from its untripped to its tripped condition.

25. The container according to claim 14, wherein the output further comprises an LED, the LED mounted in a manner so that it is visible from outside of the container.

26. A method of detecting unauthorized entry into a container including an enclosure defining an interior volume for holding tools or other belongings, a door adapted to move between an open position allowing access to the interior volume of the enclosure and a closed position for closing the enclosure, and a trip having a tripped condition and an untripped condition, the method comprising:
changing the trip from its untripped condition to its tripped condition;
sensing whether the trip is in the tripped position; and
triggering an alarm if the trip is in the tripped position.

27. The method according to claim 26, further comprising the changing including moving a latch of the container from an latched position to an unlatched position using a latch actuator of the container, the latch securing the door to the enclosure when the door is in its closed position and the latch is in the latched position, the latch permitting relative movement of the door and enclosure when in the unlatched position, the latch actuator being the trip and operatively connected to the latch in a manner so that movement of the actuator from the untripped position to the tripped position causes the latch to move from its latched position to its unlatched position, the trip sensor further adapted to sense the position of the latch actuator.

28. The method according to claim 27, further comprising sensing the position of a lock of the container, the lock to prevent opening of the door when in a first position, to permit opening of the door when in a second position, and the method further comprising triggering the alarm only if the lock is locked and the actuator is in its second condition.

29. The method according to claim 26, further comprising providing power to a circuit if the trip is in its tripped position, the circuit sensing whether the trip is in its tripped position by receiving power.

30. The method according to claim 26, further comprising guiding the trip to prevent relative motion in at least one direction between the actuator and the housing.

31. The method according to claim 26, further comprising adapting a housing of the circuit to mate with a lip of the enclosure.

32. The method according to claim 26, further comprising mating the housing to the lip of the enclosure.

33. An alarm for a container including an enclosure defining an interior volume for holding tools or other belongings, a door adapted to move between an open position allowing access to the interior volume of the enclosure and a closed position for closing the enclosure, a latch moveable between a latched position to secure the door to the enclosure when the door is in its closed position and an unlatched position wherein relative movement of the door and enclosure is permitted, and an actuator operatively connected to the latch in a manner so that movement of the actuator from a first position to a second position causes the latch to move from its latched position to its unlatched position, the alarm comprising:
a power source;
a normally open actuator switch, the actuator adapted to close the actuator switch if the actuator moves from its first position to its second position, the actuator switch connected to the power source;
a circuit connected to the actuator switch to sense the position of the actuator switch by receiving power via the actuator switch; and
an output, the circuit to drive the output if the actuator switch is closed.

34. The alarm according to claim 33 further comprising a power source.

35. The alarm according to claim 34, wherein the power source is internal to the alarm.

36. An alarm for a container including an enclosure defining an interior volume for holding tools or other belongings, a door adapted to move between an open position allowing access to the interior volume of the enclosure and a closed position for closing the enclosure, a latch moveable between a latched position wherein the latch engages both the door and the enclosure in a manner to secure the door to the enclosure when the door is in its closed position and an unlatched position wherein relative movement of the door and enclosure is permitted, and an actuator operatively connected to the latch in a manner so that movement of the actuator from a first position to a second position causes the latch to move from its latched position to its unlatched position, the enclosure including a protrusion in the interior volume, the alarm comprising:
a housing with a recess adapted to mate with the protrusion;
an actuator switch adapted to move between a first position and a second position when the actuator moves between its first and second positions;
a circuit in the housing and adapted to sense the position of the actuator switch;
an output, the circuit to drive the output if the actuator switch is in its second position.

37. The alarm according to claim 36, further comprising a power supply, the actuator switch connecting the power supply to the circuit if the actuator switch is in its second position, the circuit sensing the position of the actuator switch by receiving power from the actuator switch.

38. The alarm according to claim 36, further comprising a guide, the actuator to slidably engage the guide, whereby the guide prevents relative movement between actuator and the actuator switch in at least one direction.

39. The alarm according to claim 36, wherein the guide is in the housing.

40. The alarm according to claim 36, further comprising a lock switch, the container to include a lock to prevent opening of the door when in a first position, to permit opening of the door when in a second position, and to close the lock switch when in its first position, the circuit further adapted to sense the position of the lock switch and to drive the output only if the lock switch is closed and the actuator sensor is in its second condition.

41. The alarm according to claim 40, wherein the lock switch is in the housing.

42. The alarm according to claim 40, further comprising the lock switch and the actuator switch are connected in series.

43. The alarm according to claim 36, further comprising an adaptor coupled to the actuator and to engage the actuator switch when the actuator is in its second position.

44. The alarm according to claim 36 wherein the protrusion is a lip abutting the door and the recess is a notch.
